(19) United States
(12) Patent Application Publication
(10) Pub. No.: US 2005/0166323 A1
(43) Pub. Date: Aug. 4, 2005

(54) Movable bed

(76) Inventors: Hideo Kawakami, Hirakata-shi, Osaka-fu (JP); Kenji Taguchi, Hirakata-shi, Osaka-fu (JP); Atsushi Ogawa, Kyoto-shi, Kyoto-fu (JP)

Correspondence Address: McDermott Will & Emery, 600 13th Street, N W, Washington, DC, 20005-3096, US

(21) Appl. No.: 10/506,420

(22) PCT Filed: Aug. 28, 2003
(86) PCT No.: PCT/JP03/10905

(30) Foreign Application Priority Data
Sep. 4, 2002 (JP) 2002-258976

(51) Int. Cl. A61G 7/015

(52) U.S. Cl. 5/610; 5/618; 5/613

(57) ABSTRACT

An adjustable bed including a laterally tiltable platform, a tilt mechanism that tilts the platform laterally, and a load-applying unit that applies, in a state in which the platform is tilted within a predetermined angle range during operation of the tilt mechanism, a load to the platform in a direction that suppresses an expansion of the tilt angle, so as to prevent one of a compression load and a tension load exerted on the tilt mechanism by the platform from reversing to the other load type. The adjustable bed may be structured so that the predetermined angle range includes a tilt angle at which a gravitational center of the platform during the tilt operation traverses a vertical line containing a rotational center of the platform with the load-applying unit in a non-operational state.

### TECHNICAL FIELD

The present invention relates to adjustable beds for use in nursing care and the like, and particularly to an adjustable bed having a platform that tilts toward both sides in a width direction of the bed.

### BACKGROUND ART

Generally, adjustable beds used as nursing-care beds (hereinafter simply “bed”) include a turning mechanism to assist in the turning of care recipients in order to prevent the occurrence of decubitus ulcers, more commonly known as bedsores. This turning mechanism operates, for example, to tilt a platform surface of the bed to both the left and right sides (width direction), and turn a care recipient lying on the bed in a direction of the incline so as to assist in postural changes.

FIGS. 13A to 13C show a nursing-care bed assisting the turning of a care recipient as seen from the head end of the bed. The bed given here includes, as shown in FIG. 13A, a platform 1015 having a platform surface, and a fixed stage 1030 that supports platform 1015. Fixed stage 1030 includes a support base 1032 on which platform 1015 is placed, and elevation units 1035L/1035R that elevate the left and right sides of platform 1015 independently. Underneath platform 1015 is attached a left/right pair of rollers 1202 and 1203 in a longitudinal direction, platform 1015 resting on support base 1032 via roller 1202/1203.

When, as shown in FIGS. 13B and 13C, one side (left side) of platform 1015 is raised by elevation unit 1035L in a bed having this structure, roller 1202 on the other side (right side) rolls over support base 1032 toward the raised side (left side), and platform 1015 tilts (rotates) in an x direction with the center of roller 1202 as the rotational center.

However, the following problem exists with this conventional bed.

For example, when the bed is tilted laterally to the right as shown in FIG. 13B, a rotational moment M1 generated around the rotational center (i.e. center of left-side roller 1202) is anti-clockwise; that is, rotational moment M1 acts against the elevation of the side of platform 1015 (opposite of x direction in FIG. 13B). As a result, elevation unit 1035L is subject to a compression load from platform 1015.

Furthermore, if platform 1015 continues to be tilted in this state, the position of a resultant W (i.e. resultant force) of the gravitational centers of the care recipient and platform 1015 moves to the right of a vertical line C containing (i.e. passing through) the rotational center, and the rotational moment M1 around the fulcrum changes to clockwise; that is, the rotational moment M1 is reversed to act in the same direction (x direction in FIG. 13C) as the elevation of the side of platform 1015 by elevation unit 1035L. As a result, the compression load brought to bear on elevation unit 1035L until this point changes to a tension load.

Since there is, with this adjustable bed, a slight amount of play in parts where the components are coupled to one another due to the nature of the manufacturing process, the relative positions of these coupling parts changes instantaneously when a load reversal as described above occurs, causing the operation of the adjustable bed to become intermittent, and resulting in jolting/jarring motion. Also, since the compression load on elevation unit 1035L is suddenly removed, instantaneously releasing elevation unit 1035L from the load applied until then, the speed of the tilting operation increases momentarily, causing uneven operation. The smooth operation of the adjustable bed is compromised for these reasons, resulting in discomfort to the care recipient lying on platform 1015.

Also, the adjustable bed given here is mostly used by elderly people in need of nursing care and people suffering serious illnesses. As such, jarring motion and variations in the tilt speed that occur during the operation of platform 1015 may, for example, wake up a bed user who is sleeping. Since the possibility exists of stress and psychological anxiety being caused to the bed user, this area of adjustable beds is still in need of improvement.

Improving the precision of the coupling parts of the bed is one of the measures considered to date in order to prevent stress, psychological anxiety and the like being caused to bed users, although the cost hikes involved make this hardly a viable option.

### DISCLOSURE OF THE INVENTION

The present invention, which arose in view of the above problems, aims to provide an adjustable bed capable of tilting a platform of the bed so as not to subject a bed user to unnecessary stress.

In order to achieve the above object, an adjustable bed pertaining the present invention includes a laterally tiltable platform; a tilt mechanism adapted to tilt the platform laterally; and a load-applying unit adapted to apply, in a state in which the platform is tilted within a predetermined angle range during operation of the tilt mechanism, a load to the platform in a direction that suppresses an expansion of the tilt angle, so as to prevent one of a compression load and a tension load exerted on the tilt mechanism by the platform from reversing to the other load type.

Here, the predetermined angle range may include, specifically, an angle at which a gravitational center of the platform during the tilt operation traverses a vertical line containing a rotational center of the platform with the load-applying unit in a non-operational state. More specifically, the range may be from 30 degrees to 90 degrees inclusive, with reference to the platform in a horizontal state.

Since the load on the tilt mechanism from the platform during operation is, according to these structures, maintained throughout as either a compression load or a tension load, it is possible to prevent intermittent operation of the adjustable bed. Since this construction preventing load reversals means that reversals in the load on the coupling parts do not occur with the present invention, even if, for instance, play exists structurally in the construction of the adjustable bed, particularly in the coupling parts of the tilt mechanism, it is possible to effectively prevent the jerkiness and sudden variations in speed of conventional beds during operation caused by this play. The prevent invention thus enables the bed user to feel relaxed about using the bed, without any stress or psychological anxiety being caused.

Note that the load-applying unit may be constituted from a tension spring.

Also, the load-applying unit may have a first member and a second member that, in combination, extend in proportion to a slope of the platform, and a compression spring disposed so as to apply a load in a direction that retracts the combination of the first and second members when the slope of the platform reaches a predetermined tilt angle, and the predetermined tilt angle may be an angle immediately prior to an angle at which a rotational moment around a rotational center that acts on the platform, reverses direction due to self weight during the operation of the tilt mechanism.

Furthermore, the load-applying unit may include a compression spring adapted to apply, at a start of the tilting operation, a load in a direction that extends the combination of the first and second members.

More specifically, the tilt mechanism may include an elevation unit disposed on either side of the platform, in order to elevate the platform up and down, and the platform may be tilted laterally by driving one of the elevation units.

Also, the platform may be placed on a support base via a roller disposed on either side of the platform, and when one side of the platform is raised by the elevation unit corresponding to the side, the roller on the other side may roll over the support base toward the side being raised, and the platform may tilt with a center of the roller on the other side as a rotational center.

### BRIEF DESCRIPTION OF THE DRAWINGS

FIG. 1 is schematic view of a turning bed in an embodiment 1;

FIG. 2 is a cutaway view of part of the turning bed in embodiment 1;

FIG. 3 is a perspective view of the overall bed;

FIGS. 4A & 4B are longitudinal sectional views of a bed frame and an adjustable stage;

FIGS. 5A & 5B are transverse sectional views of the bed frame and the adjustable stage;

FIG. 6 is a plan view of the bed with the bed frame removed;

FIG. 7 is a perspective view of the bed with the bed frame removed;

FIG. 8 is a perspective view of the adjustable stage (elevated) and a fixed stage;

FIG. 9 is schematic view of a left-side elevation unit as seen from the inside;

FIG. 10 is a perspective view of a platform that has been rolled laterally;

FIG. 11A to 11C schematically show a rotational moment generated when the adjustable stage rolls to face right;

FIG. 12 is a sectional view of a load-applying unit in an embodiment 2; and

FIGS. 13A to 13C schematically show a rotational moment generated when a platform in a conventional adjustable bed rolls to face right.

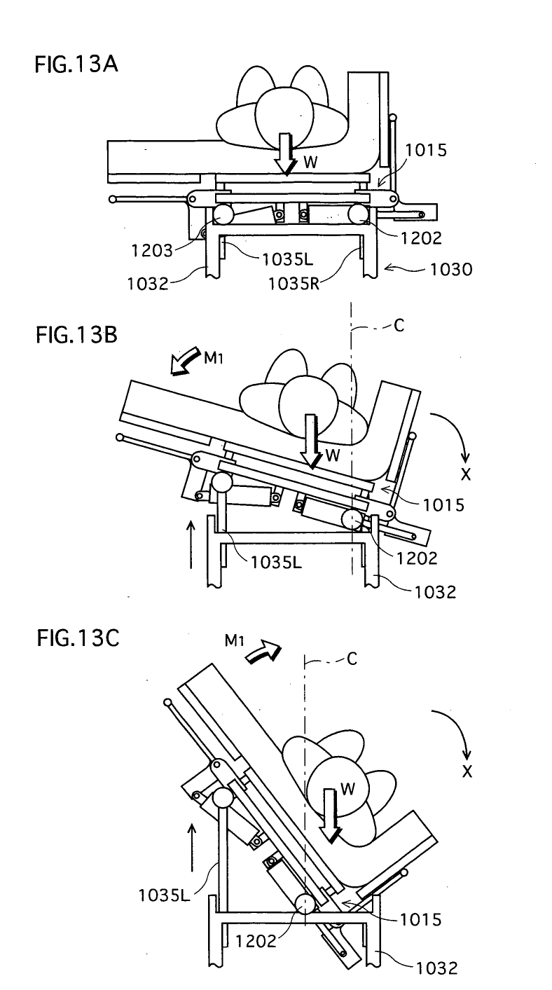

### BEST MODE FOR CARRYING OUT THE INVENTION

Embodiments in which an adjustable bed pertaining to the present invention is applied to a turning bed are described below with reference to the drawings.

### Embodiment 1

1-1. Structure of Turning Bed

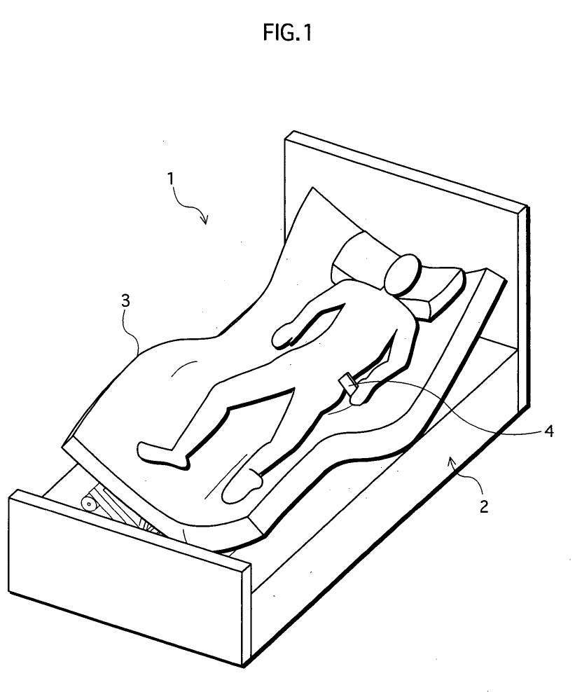

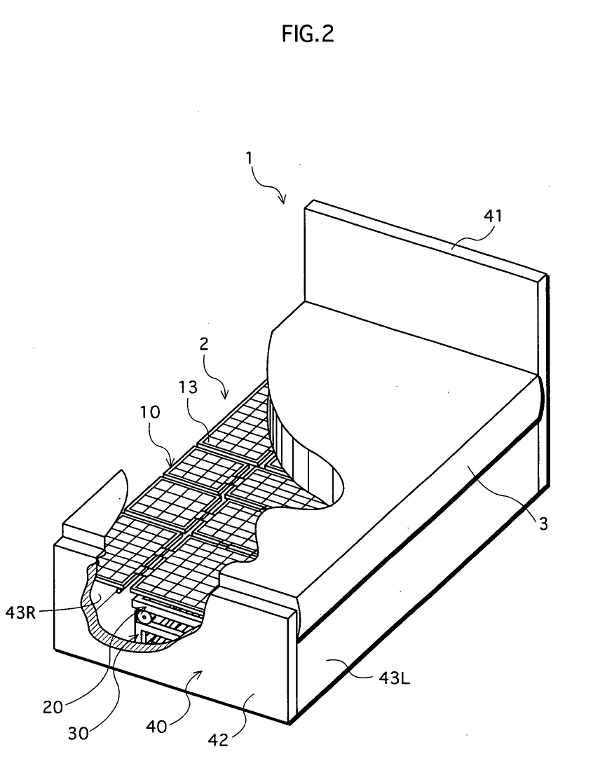

FIG. 1 is a schematic view showing a structure of a turning bed 1 pertaining to an embodiment 1. FIG. 2 is a cutaway perspective view of a section of turning bed 1.

Turning bed 1 (hereinafter, simply “bed 1”) includes, as shown in FIGS. 1 and 2, a main body 2 of the bed that includes an adjustable platform surface 13 (see FIG. 2), a mattress 3 placed on platform surface 13, and a remote controller 4 for operating platform surface 13.

By operating remote controller 4, the care recipient, for example, raises their upper body from a supine position (hereinafter, “sitting-up position”), raises their knees (hereinafter, “knee-break”), and furthermore, as shown in FIG. 1, changes their posture from a supine position to a left lateral position, for example.

Here, a posture that includes at least one of the sitting-up and knee-break positions is referred to as a “flexion position”, and the tilting of platform surface 13 of main body 2 in a longitudinal direction so as to obtain such a posture is referred to as “flexing” platform surface 13.

On the other hand, postural changes from a supine to a lateral position are referred to as “turning” the care recipient. In order to distinguish between the above longitudinal tilts of platform surface 13, the tilting of platform surface 13 to the left or right (i.e. in a width direction of the bed) is referred to as “rolling” platform surface 13.

1-2. Structure of Remote Controller

Remote controller 4 is provided as operating units for flexing, elevating, and rolling platform surface 13 of main body 2, when changing the position or posture of a care recipient. Remote controller 4 has a height operating unit that elevates platform surface 13 up and down to adjust the height, a head operating unit that lifts the care recipient's upper body, a leg operating unit that flexes the care recipient's knees, and a turning operating unit that turns the care recipient to the left or right.

1-3. Structure of Main Body

With main body 2, platform surface 13 flexes to assist the care recipient achieve sitting-up and knee-break positions, and platform surface 13 also rolls to the left/right to assist the care recipient with turning from a supine to a lateral position.

Main body 2, as shown in FIG. 2, includes an inner bed frame 10 structuring adjustable platform surface 13, an adjustable stage 20 for moving bed frame 10, a fixed stage 30 that supports adjustable stage 20, and an outer bed frame 40 that encompasses the above components 10, 20, 30 and 40. Note that the platform is here constituted from inner bed frame 10 and adjustable stage 20.

Moreover, as shown in FIG. 1, when platform surface 13 rolls to the left, for example, a section of platform surface 13 on the left side rises to support the care recipient from the side (left side in FIG. 1), in order to prevent the care recipient from falling out of bed 1.

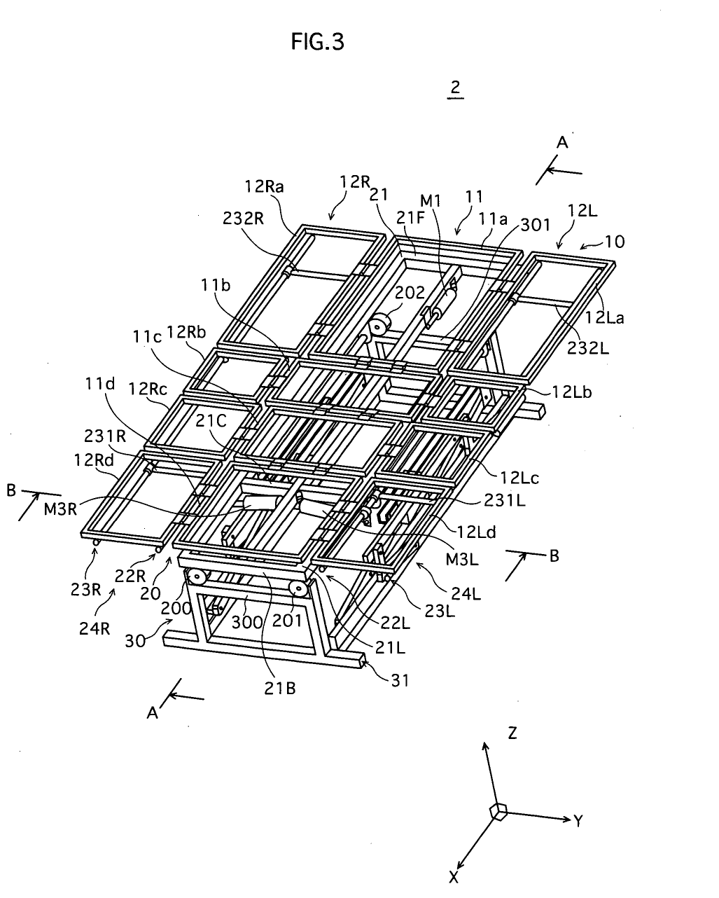

FIG. 3 is a perspective view showing main body 2 without outer bed frame 40.

The following description relates to the structure of inner bed frame 10, adjustable stage 20, and fixed stage 30.

1-3-1. Structure of Inner Bed Frame

Inner bed frame 10 is partitioned in three—middle section 11, right-side section 12R, and left-side section 12L—in a crosswise direction of bed 1 (ydirection in FIG. 3; also referred to as a “latitudinal direction”), in order to, for example, flex/roll platform surface 13 as described above, and raise the side sections when platform surface 13 is rolled. Furthermore, sections 11, 12R and 12L are each partitioned, in a lengthwise direction (x direction in FIG. 3; also referred to as a “longitudinal direction”) of bed 1, into four sections corresponding to the back, hip, upper leg, and lower leg regions of a care recipient's body. Note that in the present specification, the directions indicating left/right are from the viewpoint of a care recipient lying on bed 1.

With respect to middle section 11 positioned in a middle of bed 1 in the crosswise direction, the part corresponding to the care recipient's back is, as shown in FIG. 3, referred to as a back portion 11a. Likewise, the parts corresponding to the hip, upper-leg, and lower-leg regions are referred to as a hip portion 11b, an upper-leg portion 11c, and a lower-leg portion 11d. Similarly, the parts of right-side section 12R corresponding respectively to the care recipient's back, hip, upper-leg, and lower-leg regions are referred to as a back portion 12Ra, a hip portion 12Rb, an upper-leg portion 12Rc, and a lower—leg portion 12Rd, and the parts of right-side section 12L corresponding respectively to the back, hip, upper-leg, and lower-leg regions are referred to as a back portion 12La, a hip portion 12Lb, an upper-leg portion 12Lc, and a lower-leg portion 12Ld.

Also, “middle section 11”, used hereinafter, means the entirety including back portion 11a, hip portion 11b, upper-leg portion 11c, and lower-leg portion 11d (four parts). Similarly, “right-side section 12R” means the entirety including back portion 12Ra, hip portion 12Rb, upper-leg portion 12Rc, and lower-leg portion 12Rd (four parts), while “left/right side sections 12L/R” means the entirety including back portion 12La, hip portion 12Lb, upper-leg portion 12Lc, lower-leg portion 12Ld, back portion 12Ra, hip portion 12Rb, upper-leg portion 12Rc, and lower-leg portion 12Rd (eight parts).

A wire mesh is, as shown in FIG. 2, stretched across the surface (platform surface 13) of bed frame 10, although in FIG. 3, this wire mesh has been omitted so as to clearly represent the structures of other members, parts, and the like.

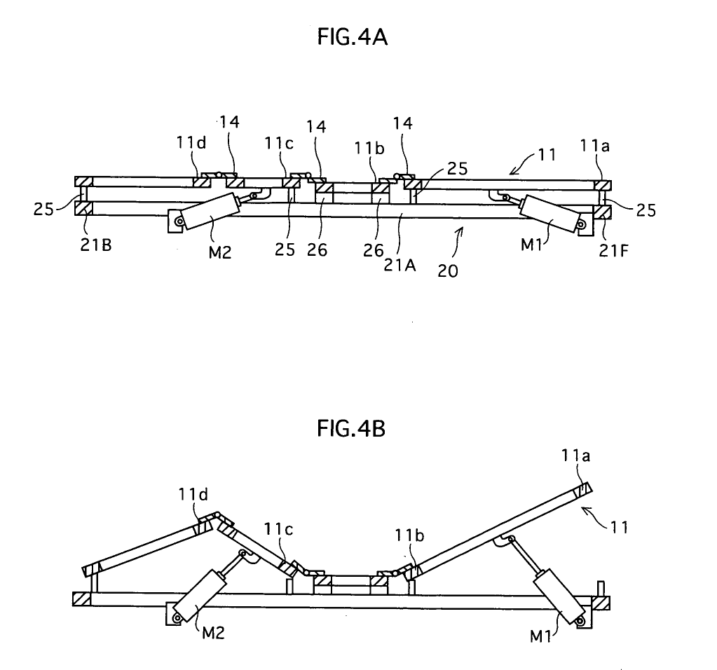

FIGS. 4A and 4B are longitudinal sectional views of bed frame 10 and adjustable stage 20 along the A-A line in FIG. 3, FIG. 4A showing bed frame 10 in a horizontal state, and FIG. 4B showing bed frame 10 in a flexed state.

Middle sections 11a-lld are, as shown in FIG. 4A, supported by adjustable stage 20 with a gap therebetween (i.e. via spacers 25, for example). Hip portion 11b is fixed to spacers 26, which are secured to adjustable stage 20, by welding or the like. Bed frame is thus secured to adjustable stage 20.

Middle sections 11a-lld are each pivotally coupled via hinges 14 to middle sections adjacent in the lengthwise direction of bed 1. Since the axial pins of hinges 14 are disposed in the crosswise direction (i.e. orthogonal to the page), not only do back portion 11a and upper-leg portion lic both flex in relation to hip portion 11b, but lower-leg portion 11d flexes with the flexing of upper-leg portion 11c.

Moreover, the flexing of back portion 11a, upper-leg portion 11c, and lower-leg portion 11d is performed by direct-acting actuators M1 and M2, which operate in accordance with button operations to the head and leg operating units of remote controller 4. Also, in order to distinguish actuators M1/M2 from other actuators described below, actuator M1 in a vicinity of the care recipient's head is referred to as head-end actuator M1, and actuator M2 in a vicinity of the care recipient's legs is referred to as foot-end actuator M2.

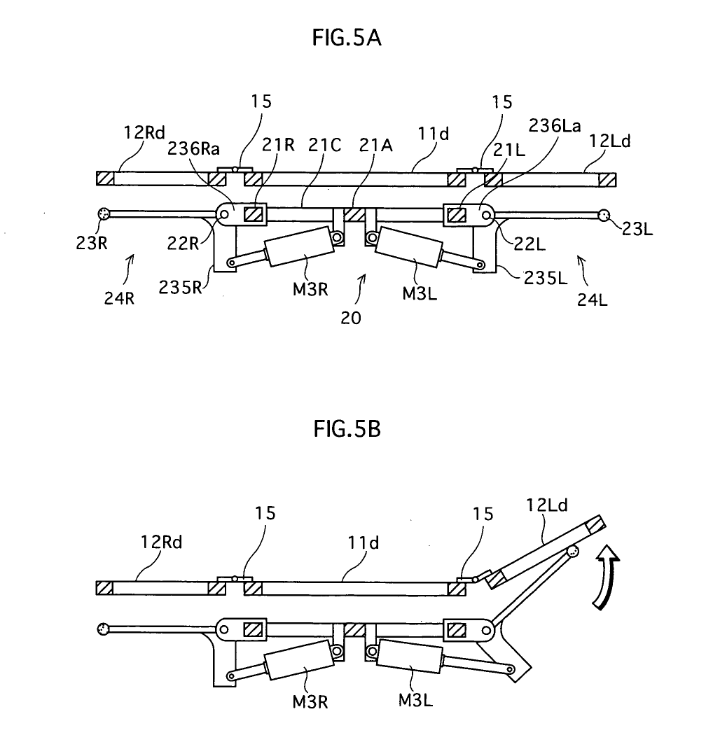

FIGS. 5A and 5B are transverse sectional views of bed frame 10 and adjustable stage 20 along the B-B line in FIG. 3, FIG. 5A showing bed frame 10 in a horizontal state, and FIG. 5A showing left-side section 12L in a raised state.

Middle sections 11a-11d are, as shown in FIGS. 3, 5A and 5B, pivotally coupled via hinges 15 to right/left-side sections 12Ra-12Rd and 12La-12Ld on the left and right. Since the axial pins of hinges 15 are disposed in the lengthwise direction, side sections 12R and 12L can be raised relative to middle sections 11. Moreover, the raising of side sections 12R and 12L is, as shown in FIG. 5B, performed by right/left support frames 24R/24L, which are raised by actuators M3R and M3L that operate in accordance with button operations to the turning operating unit of remote controller 4.

1-3-2. Structure of Adjustable Stage

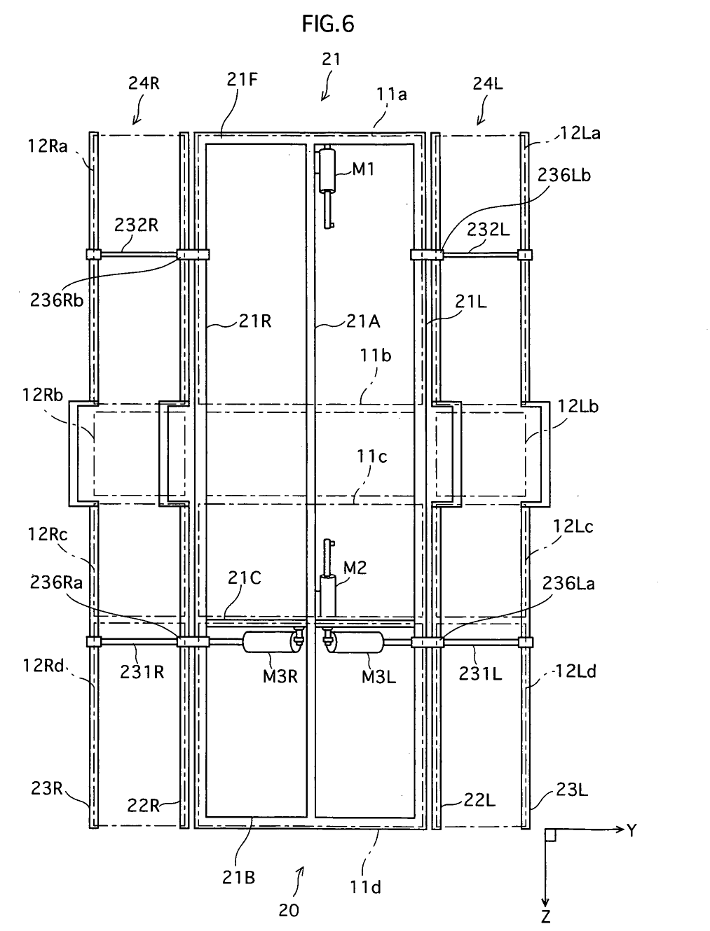

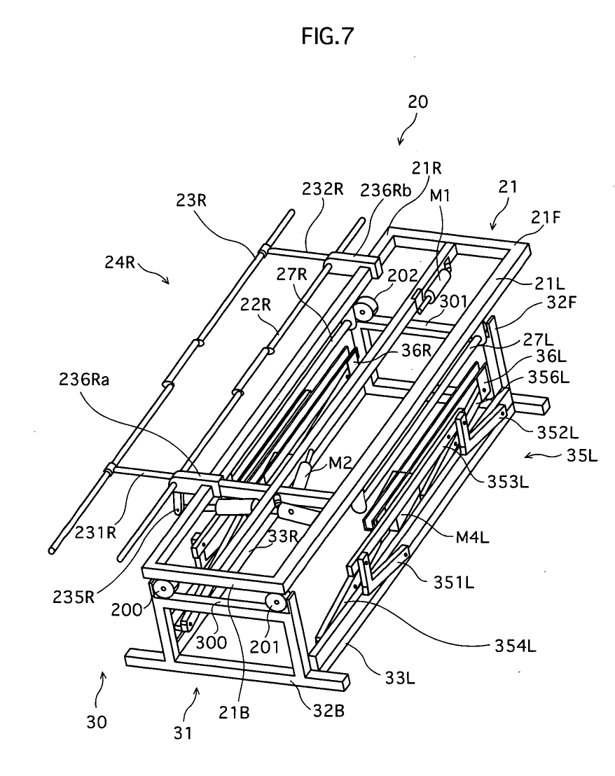

FIG. 6 is a plan view of main body 2 with bed frame 10 in FIG. 3 having been removed, and FIG. 7 is a perspective view of main body 2 with bed frame 10 in FIG. 3 having been removed.

Adjustable stage 20 includes, as shown in FIG. 3 and FIGS. 5 to 7, a rectangular stage frame 21 that is long in the longitudinal direction of bed 1, and support frames 24R/24L on the left/right that support and raise right/left side sections 12R/12L of bed frame 10. Note that in FIG. 7 depiction of support frame 24L has been omitted.

Stage frame 21, as shown in FIG. 6, includes a pair of lengthwise members 21R/21L that are parallel in the longitudinal direction, and a pair of crosswise members 21F/21B that are coupled in the latitudinal direction to both ends of the pair of lengthwise members 21R/21L. Frame 21 is reinforced by a lengthwise reinforcing member 21A that couples the pair of crosswise members 21F/21B at a substantial center between lengthwise members 21R/21L, and a crosswise reinforcing member 21C that couples lengthwise reinforcing member 21A with lengthwise members 21R/21L at the foot-end of bed 1.

Head-end actuator M1, which has a rod coupled at one end to back portion 11a, is, as shown also in FIGS. 4A and 4B, attached to a head-end of lengthwise reinforcing member 21A. Back portion 11a, which assists the care recipient achieve a sitting-up position, is raised/lowered (flexed), as shown in FIG. 4B, by extending and retracting this rod.

Also, foot-end actuator M2, which has a rod coupled at one end to back portion 11c, is, as also shown in FIGS. 4A and 4B, attached to a foot-end of lengthwise reinforcing member 21A. Upper-leg portion 11c, which assists the care recipient achieve a knee-break position, is raised/lowered (flexed), as shown in FIG. 4B, by extending and retracting this rod.

Support frames 24R/24L are, as shown in FIG. 3 and FIGS. 5 to 7, attached to lengthwise members 21R/21L on the right and left of stage frame 21 via coupling members 236Ra/236Rb and 236La/236Lb.

Since support frames 24R/24L have the same structure and differ only with respect to positioning (i.e. right/left), the following description relates only to support frame 24R on the right side. Note that the reference numbers of the various members structuring left support frame 24L are obtained by changing the “R” at the end of the reference numbers used with right support frame 24R described below to an “L”.

Support frame 24R is constituted, in a ladder-shape, from a pair of lengthwise struts 22R and 23R disposed in a lengthwise direction, and two crosswise struts 231R and 232R that couple the pair of lengthwise struts 22R and 23R in the crosswise direction. As a result of lengthwise strut 22R on the inside being pivotally supported by coupling members 236Ra/236Rb secured to lengthwise member 21R of stage frame 21, support frame 24R is able to pivot with lengthwise strut 22R as the central axis.

Extended parts 235R/235L, which extend downwards, are, as shown in FIGS. 5A and 5B, secured to lengthwise struts 22R/22L, and the rods of right/left actuators M3R/M3L, which extend and retract in the crosswise direction, are secured to these extended parts 235R/235L. When the rods of right/left actuators M3R/M3L extend, support frames 24R/24L pivot around the axial center of lengthwise struts 22R/22L on the inside and are raised, which supports and raises right/left side sections 12R/12L from underneath.

Moreover, right/left actuators M3R/M3L are, as also shown in FIGS. 5A and 5B, attached to lengthwise reinforcing member 21A and crosswise reinforcing member 21C, and operated by the operation of operation buttons on the turning operating unit of remote controller 4, for example.

1-3-3. Structure of Fixed Stage

Fixed stage 30 is, as shown in FIGS. 3 and 7, formed from a support base 31 that supports adjustable stage 20, and a right/left pair of elevation units 35R/35L for elevating adjustable stage 20 up and down, and tilting the adjustable stage to the right/left.

Support base 31 is constituted from a pair of erection frames 32B/32F disposed one at each end in a lengthwise direction, and a pair of coupling members 33R/33L coupling erection frames 32B/32F in a longitudinal direction. Elevation units 35R/35L are provided on both the right and left sides of support base 31 between erection frames 32B/32F. Elevation units 35R/35L on both the left and right are operated when elevating adjustable stage 20, and one of elevation units 35R/35L is operated when tilting adjustable stage 20 to the left or right.

Since one of elevation units 35R/35L raises one side of adjustable stage 20 when rolling adjustable stage 20 to the left or right, the other side of adjustable stage 20 needs to shift closer to side being raised. For this reason, rollers 200, 201, 202 and 203 that roll to the right and left on top surfaces 300 and 301 of erection frames 32B/32F are attached to an underside of adjustable stage 20, the rotational center (axis) when adjustable stage 20 is tilted being a line segment connecting the centers of rollers (e.g. rollers 200/202) that roll over top surfaces 300 and 301 of erection frames 32B/32F.

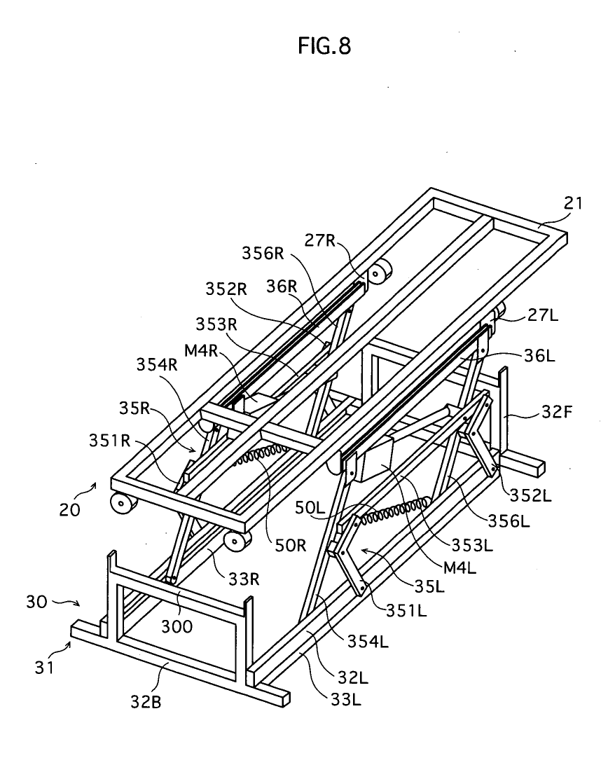

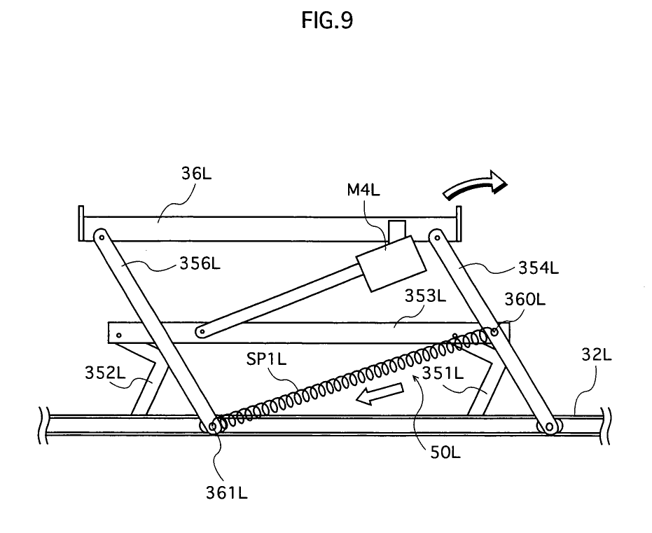

FIG. 8 is a perspective view of fixed stage 30 with adjustable stage 20 in an elevated state, and FIG. 9 is a lateral view of elevation unit 35L from the right side.

Elevation units 35R/35L will now be described. The following description relates to elevation unit 35L, since units 35R/35L differ only in their positioning on the right and left sides.

Note that the reference numbers of the various members structuring left elevation unit 35R are obtained by changing the “L” at the end of the reference numbers used with left elevation unit 35L described below to an “R”.

Elevation unit 35L is, as shown in FIG. 7, structured so as to receive a stage bar 27L attached to lengthwise member 21L of adjustable stage 20 from below using bar receiver 36L. Adjustable stage 20 is raised as a result of bar receiver 36L being raised in this state (the raising of bar receiver 36L is also referred to as “extending” the elevation unit).

Moreover, so that stage bars 27R/27L rotate smoothly within bar receiver 36R/36L when rolling adjustable stage 20, stage bars 27R/27L are, for example, circular in cross-section, while bar receiver 36R/36L are correspondingly U-shaped in cross-section.

Coupled to bar receiver 36L is, as shown FIG. 8, a pair of support arms 354L/356L, freely raisable/lowerable at both ends in a lengthwise direction of bar receiver 36L, which is elevated by the up/down movement of these support arms 354L/356L. Also, the lower ends of support arms 354L/356L are structured to move within a guiding member 32L in a lengthwise direction, when support arms 354L/356L are raised/lowered, thus enabling bar receiver 36L to be elevated in a perpendicular (up/down) direction.

Support arms 354L/356L are pivotally coupled to the flexed part of L-shaped members 351L and 352L, which are coupled at one end to guiding member 32L. The ends of L-shaped members 351L and 352L opposite the ends coupled to guiding member 32L are coupled to a horizontal link member 353L, and an actuator M4L is attached at an angle between this link member 353L and bar receiver 36L. By extending/retracting the rod of actuator M4L, L-shaped members 351L and 352L pivot on the coupling points with guiding member 32L, and support arms 354L/356L coupled to L-shaped members 351L and 352L are raised/lowered.

So that stage bars 27R/27L do not dislodge from bar receivers 36R/36L once bar receivers 36R/36L have received stage bars 27R/27L from below, a safety mechanism that includes a belt, a chain, a spring and the like, is provided between stage bars 27R/27L and bar receivers 36R/36L.

On elevation unit 35L is provided a load-applying unit 50 that applies a load in a direction that reduces the incline when adjustable stage 20 is tilted within a range of at least 30 degrees to 90 degrees inclusive, with reference to a horizontal state of the platform, for example. This range includes an angle at which the position acted on by a resultant of the gravitation forces of adjustable stage 20 and the care recipient traverses (i.e. crosses or passes through) a vertical line C containing the rotational center. In other words, load-applying unit 50 applies a load in a direction (downward) that reduces the lift of bar receiver 36L included in elevation unit 35L.

The tilt angle of the platform when the position acted on by the resultant of the gravitation forces of adjustable stage 20 and the care recipient traverses vertical line C containing the rotational center varies depending, for instance, on the care recipient's weight and position on the bed. Considering these factors that include the care recipient's weight and position, a tilt angle of 30 degrees is the smallest angle for use of bed 1 under normal conditions. Also, in relation to the maximum angle, it is difficult to imagine bed 1 being used beyond a tilt angle of 90 degrees in terms of safety.

Specifically, load-applying unit 50 is constituted from a tension spring SP1L attached to the pair of support arms 354L/356L. Tension spring SP1L is disposed substantially parallel to the direction in which the rod of actuator M4L extends/retracts, and applies a load on elevation units 35R/35L when the platform begins to roll.

The rod of actuator M4L is extended/retracted as a result of the height and turning operating units of remote controller 4 being operated.

1-3-4. Structure of Outer Bed Frame

Outer bed frame 40 is, as shown in FIGS. 1 and 2, constituted from a headboard 41 disposed at the head-end of bed 1, a footboard 42 disposed at the foot-end of bed 1, and a left/right pair of sideboards 43R/43L that couple headboard 41 and footboard 42 below the sides of a mattress 3. Headboard 41, footboard 42, and sideboards 43R/43L enhance the design of bed 1, as well as preventing the bed user from being mistakenly sandwiched between the surface on which bed 1 is established (e.g. floor) and the raised bed frame 10, for instance.

2. Operation of Turning Bed

2-1. Elevation Operation

When, with bed 1, an operation of the height operating unit is instructed using remote controller 4, the rods of both actuators M4R/M4L in elevation units 35R/35L extend out, and support arms 354R/354L and 356R/356L rise up, as shown in FIG. 8. As a result, bar receivers 36R/36L receive stage bars 27R/27L from below, and continue to rise up in this state. Adjustable stage 20 (platform surface 13 of bed 1) is thus raised.

On the other hand, when there is a lower operation of the height operating unit of remote controller 4 with platform surface 13 in a raised state, the rods of actuators M4R/M4L in elevation units 35R/35L retract, and platform surface 13 begins to drop in height.

2-2. Sitting-Up Operations

When, with bed 1, an operation of the head operating unit is instructed using remote controller 4, the rod of head-end actuator M1 extends out, and back portion 11a in the middle begins to rise in accordance with the extension of the rod, in a direction that raises the upper body, as shown in FIG. 4B. At this time, back portions 12Ra/12La on the right/left of back portion 11a, being coupled to back portion 11a via hinges 15, rise together with back portion 11a.

On the other hand, when an operation of the head operating unit is instructed using remote controller 4 with back portions 11a/12Ra/12La in the middle and sides in a raised state, the rod of head-end actuator M1 is retracted and back portions 11a/12Ra/12La begin to return to a flat state.

2-3. Knee-Break Operation

When, with bed 1, an operation of the leg operating unit is instructed using remote controller 4, the rod of foot-end actuator M2 extends out, and upper-leg portions 11c/12Rc/12Lc in the middle and right/left sides begin to rise in accordance with the extension of the rod, which at the same time raises lower-leg portions 11d/12Rd/12Ld in the middle and right/left sides, as shown in FIG. 4B.

On the other hand, when an operation of the leg operating unit of remote controller 4 is instructed with upper-leg portions 11c/12Rc/12Lc and lower-leg portions 11d/12Rd/12Ld in the middle and sides in a raised state, the rod of foot-end actuator M2 is retracted and portions 11c/12Rc/12Lc and 11d/12Rd/12Ld begin to return to a flat state.

2-4. Turning Operation

Described here is an exemplary operation when turning a care recipient lying supine to a left lateral position, as shown in FIG. 1.

When there is an operation of the turning operating unit of remote controller 4, firstly, as shown in FIGS. 5A and 5B, the rod of left actuator M3L extends out, support frame 24L rises up around the axial center of lengthwise strut 22L on the inside, and finally, have passed through the state shown in FIG. 5B, left side section 12L rises to angle of substantially 90 degrees. Side section 12L is raised in this way so as to support the left side of the care recipient when platform surface 13 is rolled to the left, thus preventing the care recipient from falling out of bed 1.

Next, the rods of head and foot-end actuator M1 and M2 are extended, and the sitting-up and knee-break operations are performed. The most stable posture for a care recipient lying supine is a flexion position with knees bent and hips flexed, the above sitting-up and knee-break operations being performed to obtain this flexion position.

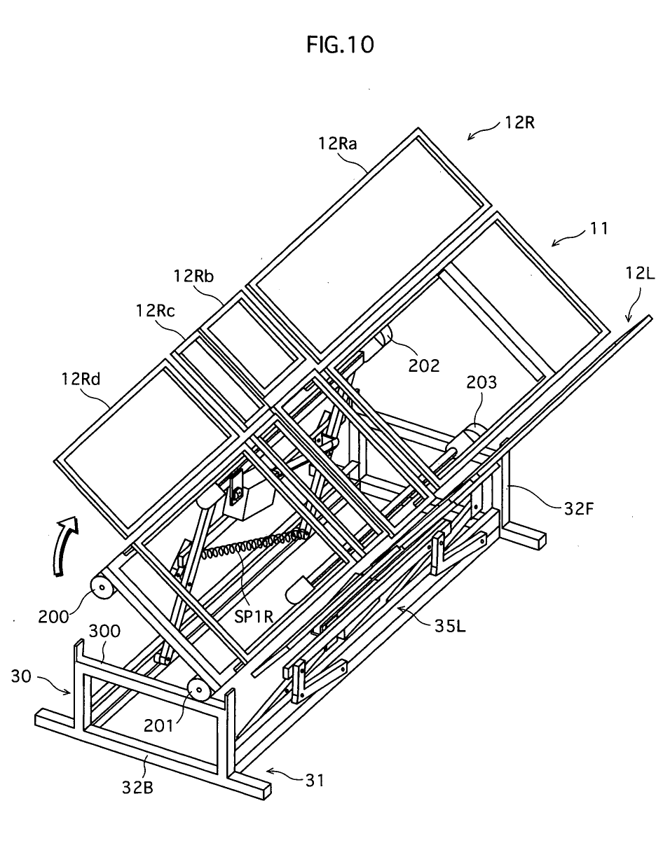

Once left side section 12L has been raised and the middle and right side sections 11 and 12R have been flexed as a result of the above operations, actuators M4R attached to elevation unit 35R on the right side is extended, and bar receiver 36R rises, receiving stage bar 27R. As a result, adjustable stage 20, as shown in FIG. 10, begins to roll to the left. In other words, the platform is tilted by right-side elevation unit 35R, raising the right side of the platform.

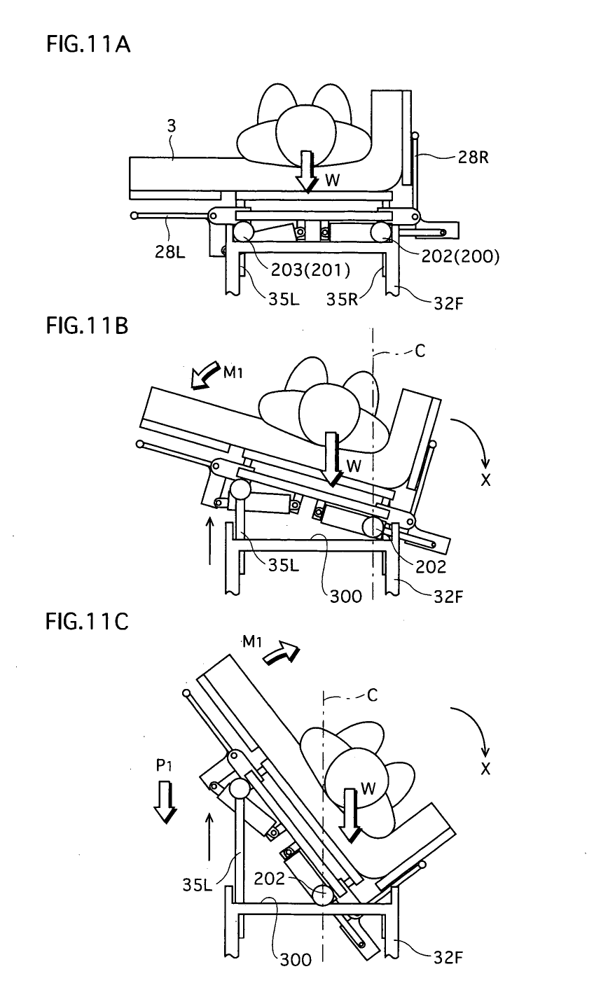

FIGS. 11A to 11C schematically show a rotational moment that occurs when adjustable stage 20 is rolled to face the right side, FIG. 11A showing adjustable stage 20 in a horizontal state prior to rolling, FIG. 11B showing a state after the rolling has started, and FIG. 11C showing a state of the rolling beyond that shown in FIG. 11B.

Once the rolling has started, the position acted on by resultant W of the gravitational forces of bed frame 10, adjustable stage 20 and the care recipient is, as shown also in FIG. 11B, to the left of vertical line C containing the rotational center, being the center of roller 202 (and 200). The rotational moment M1 around the rotational center resulting from resultant W acts in a downward direction (counter to x direction) on lowers elevation unit 35L. This results in elevation unit 35L being subjected to a compression load from adjustable stage 20.

Elevation unit 35L elevates bar receiver 36L so that a rotational moment greater than the above rotational moment M1 acts of the rotational center. Resultant W of the gravitational forces of bed frame 10, adjustable stage 20, and the care recipient referred to here equates of load-applying unit 50 not being attached (i.e. inactive).

Furthermore, as shown in FIG. 11C, when adjustable stage 20 is rolled, roller 202 (and 200) moves further to the left than in FIG. 11B, and the position of W, which indicates the resultant of the gravitational forces of bed frame 10, adjustable stage 20 and the care recipient, passes to the right of vertical line C containing the rotational center at the time, and the rotational moment M1 around the rotational center resulting from this resultant W acts in a direction (x direction) that pulls elevation unit 35L up.

However, since tension spring SP1L attached to elevation unit 35L applies a load P1 in a direction opposite to the direction in which elevation unit 35L extends when W, which indicates the resultant of the gravitational forces of adjustable stage 20 and the care recipient, traverses vertical line C containing the rotational center, compression load P1 resulting from tension spring SP1L acts on elevation unit 35L. Thus, because the compression load acts continuously from the start of the rolling, there is no operational unevenness in elevation unit 35L, even if there is up/down mechanical play in elevation unit 35L, for instance, and thus no jolting of the care recipient on bed 1. Any tendency of the operation to become intermittent is thus suppressed, enabling smooth movements to be realized.

Also, because of the compression load acting continuously on elevation unit 35L from the start of the rolling, and a load (compression) acting constantly on actuator M4L of elevation unit 35L in a direction that resists the tilting of adjustable stage 20, there is no change in type of load, even if the direction of the rotation moment M1 acting on adjustable stage 20 reverses during the tilting of adjustable stage 20. Even in this case, however, there is no operational unevenness, and no sudden changes in the rolling speed (tilt speed) of adjustable stage 20.

With the present embodiment 1, the provision of tension spring SP1L in elevation unit 35L means that any change in the type of load within elevation unit 35L during the rolling of the platform (i.e. the mutual reversal of compression and tension loads) is eliminated, although load reversal does occur at parts coupling elevation unit 35L and adjustable stage 20. However, this is not actually a problem as far as bed 1 is concerned, since any jarring motion can definitely be reduced in comparison to when there is a change in the load type within elevation unit 35L, as in the prior art.

Also, with the present embodiment 1, tension springs SP1R/SP1L begin applying a load on elevation units 35R/35L when the platform starts to roll. Since load-applying unit 50, when rolling the platform, need only begin applying a load in a direction suppressing any expansion of the slope of the platform at a predetermined angle that includes an angle at which there is a reversal in the load exerted on elevation units 35R/35L by the platform when load-applying units 50 are inactive, the tension load may be deactivated for small tilt angles of the platform by increasing the overall length of the springs.

Furthermore, the springs need not be long if one end of the springs is to move together with the raising of elevation units 35R/35L. In this case, however, the springs need to be constructed so that the moving end stops moving when the tilt angle of the platform reaches a predetermined angle.

Also, while the turning operation, as described above, is performed to (i) raise a side of, (ii) flex, and (iii) roll platform surface 13, this order in not limiting. The turning operation may be performed to (i) flex, (ii) raise a side of, and (iii) roll platform surface 13, or the flexing and side-raising may be performed at the same time, after which the rolling is performed.

2. Embodiment 2

With the above embodiment 1, tension springs SP1R/SP1L that apply a load when the platform starts rolling so as to reduce the slope of the platform, are used as load-applying units 50. With embodiment 2, load-applying units 50 comprising tension springs SP1R/SP1L used in embodiment 1 is replaced by a load-applying unit that begins applying a load in a direction that suppresses the expansion of the slope of the platform when rolled, just before there is a reversal in the load exerted on elevation units 35R/35L by the platform in the case of the load-applying unit being inactive.

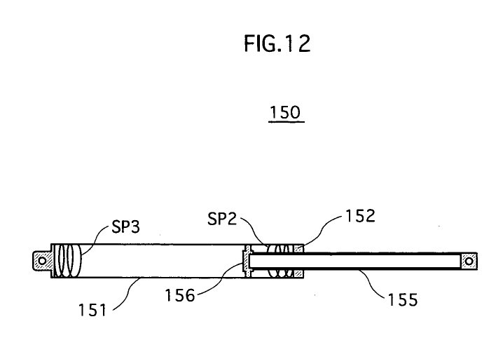

FIG. 12 shows an overall structure of a load-applying unit in embodiment 2.

Load-applying unit 150 includes, as shown in FIG. 12, a first member and a second member that are combined so as to be freely extendable/retractable, and a compression spring, a combination of the first and second members extending with increases in the slope of the platform, and the compression spring applying a load in a direction that retracts the combination of the first and second members when the slope of the platform reaches a predetermined angle.

Load-applying unit 150 includes, specifically, a cylinder 151 (first member) and a piston 155 (second member) that plugs cylinder 151. A sliding member 156 that slides on the inner circumferential wall of cylinder 151 following the in/out movement of piston 155 is attached to the end of piston 155 inserted into cylinder 151, and a guiding member 152 that guides piston 155 is attached to the end of piston 155 at which piston 155 is mated. As a result, piston 155 can be moved in/out in an axial direction of cylinder 151, enabling load-applying unit 150 as a whole to be extended/retracted.

A compression spring SP3 is attached at a bottom end within cylinder 151, and is constructed to resist the insertion of piston 155 when piston 155 is pushed deep within cylinder 151, by coming into contact with sliding member 156 at the end of piston 155.

On the other hand, a compression spring SP2 is attached at the mating end within cylinder 151, and is constructed to resist the removal of piston 155, by coming into contact with sliding member 156.

Load-applying units 150 on the right and left sides are attached respectively to the pairs of support arms 354R/356R and 354L/356L, so that piston 155 moves in/out with respect to cylinder 151 in accordance with the extension/retraction of elevation units 35R/35L in the up/down direction, as with the above embodiment 1. Consequently, compression spring SP3 applies a load in a direction that widens the interval between each pair of support arms 354R/356R and 354L/356L, in a state in which piston 155 is inserted into cylinder 151 so that the overall length of load-applying unit 150 is shortest. As such, it is possible to decrease the load on actuators M4R/M4L when elevation units 35R/35L begin rolling adjustable stage 20.

On the other hand, when piston 155 is pulled out from cylinder 151 until just before load-applying unit 150 reaches a maximum overall length, compression spring SP2 applies a load P1 in a direction that narrows the interval between support arms 354R/356R and 354L/356L. For this reason, as shown in FIG. 11C, even if rotational moment M1 around the center (rotational center) of the rollers resulting from the entire platform changes to the rolling direction, for example, there is no reversal of the load exerted on elevation units 35R/35L by adjustable stage 20 (platform). Consequently, as with the above embodiment 1, any jolting of a care recipient lying on bed 1 is eliminated, as are sudden changes in the tilt speed during the rolling.

When load-applying unit 150 is structured as described above, a load begins to be applied to elevation units 35R/35L in a direction that resists the raising of the elevation units prior to the tilt angle of the platform reaching an angle at which the gravitational center of the platform traverses a vertical line containing the rotational center of the platform, thus making it is possible to reduce the load to actuators M4R/M4L.

Here, factors such as the size of the load and the position at which load-applying unit 150 begins to apply the load to elevation units 35R/35L are determined, for example, using the rotational moments during operations to tilt the platform, as well as through actual experimentation.

The angle of the platform when load-applying unit 150 begins to apply a load to elevation units 35R/35L using compression spring SP2 is smaller than the angle at which the position acted on by the resultant of the gravitational forces of adjustable stage 20 and the care recipient traverses a vertical line C containing the rotational center, and is, for example, an angle of 30 degrees with reference to the platform in a horizontal state. As described in embodiment 1, the tilt angle of the platform when the position acted on by the resultant of the gravitational force of the care recipient traverses vertical line C containing the rotational center changes depending, for instance, on the position of the care recipient on the bed, and considering these factors (i.e. the care recipient, positioning on bed, etc.) the minimum tilt angle for use of the bed under normal conditions is 30 degrees.

Also, although in embodiment 2, load-applying unit 150 is structured to be freely extendable by combining cylinder 151 and piston 155, if one member is moveably supported by the other member, it is possible, even with other structures, to obtain similar effects to those of embodiment l. For example, a supporting unit may be provided to support a strut at two or more places so as to be freely movable back and forth, and a compression spring that applies a load to the strut in an opposite direction to the back/forth direction of the strut may be attached to the supporting unit, this configuration being suitably determined by, for instance, the attachment position of load-applying unit 150 and the space taken up by the attachment.

Furthermore, although compression springs SP2 and SP3 in cylinder 151 are provided one at each end the cylinder, a plurality of springs (e.g. a fixed number of different springs) may be used at each end, and the size of the applied load varied in accordance with the tilt angle of the platform.

3. Variations

While being described above based on embodiments 1 and 2, the present invention is, of course, not limited in content to the specific examples given in the above embodiments, and can be implemented as the following variations, for example.

3-1. Adjustable Bed

In the above embodiments 1 and 2, the present invention is structured as a turning bed applied as an adjustable bed, in which a platform flexes (inclines) in a longitudinal direction of the bed, so as to assist the care recipient achieve sitting-up and knee-break positions. That is, the platform includes an adjustable platform surface, a flex mechanism for forming a flexion position that includes at least one of a sitting-up position and a knee-break, and side-section lift mechanisms (see FIG. 5) for raising the side sections of the platform relative to the middle section of the platform.

However, the present invention can naturally also be applied as an adjustable bed that only rolls (tilts) the platform laterally. That is, the present invention should at least be an adjustable bed having the function of tilting the platform laterally (in the width direction of platform).

3-2. Platform

In the above embodiments 1 and 2, a turning bed is described in which the platform surface is flexed in a longitudinal direction of the bed. For this reason, the platform is structured from a bed frame and an adjustable stage. However, the present invention can also be applied to an adjustable bed that only tilts the platform laterally. With an adjustable bed that only tilts the platform laterally, it is also possible to provide a structure in which the adjustable stage described in embodiments 1 and 2 is eliminated, and the bed frame is tilted using a left/right pair of elevation units. Consequently, the platform in this case is the bed frame.

3-3. Position of the Load-Applying Unit

In the above embodiments 1 and 2, load-applying units 50 and 150 are provided in elevation units (tilt mechanisms) 35R/35L, which are for tilting the platform, and a load is generated in a direction that resists the raising of the platform by elevation units 35R/35L. However, as long as a load is applied that reduces the tilt of the platform, load-applying units may be provided in other positions.

With the structure in the above embodiments 1 and 2, load-applying units may, for example, be provided respectively between guiding members 32R, 32L and bar receivers 36R, 36L, or respectively between coupling members 33R, 33L and bar receivers 36R, 36L, either vertically or obliquely.

Furthermore, load-applying units may, for example, be provided respectively between support arms 354R/356R, 354L/356L and bar receivers 36R, 36L, or respectively between support arms 354R/356R, 354L/356L and guiding members 32R, 32L (coupling members 33R, 33L also possible), and a load applied in a direction that reduces the rise angle of support arms 354R/356R and 354L/356L.

Furthermore, the fixed stage and adjustable stage may be directly coupled. In comparison to the above embodiments 1 and 2 in which the play between the adjustable stage and elevation units exerts an influence, the jarring motion between the adjustable stage and elevation units is eliminated when the fixed stage and adjustable stage are directly coupled, making it possible to minimize any jolting of the care recipient.

3-4. Tilt Mechanism

The tilt mechanism in the above embodiment 1 is structured from elevation unit 35R/35L provided on respective sides of the platform so as to independently elevate the sides up and down, the platform being tilted by one of the elevation units raising the corresponding side of the platform. This procedure is not limiting, although because elevation units are provide independently on the left and right sides in embodiment 1, it is possible, for example, to combine a mechanism for adjusting the platform height, and to design for device simplification and miniaturization.

For example, the platform may be secured to a pivotal bearing around a fixed axis, and a predetermined part of the platform tilted by an actuator extending/retracting a rod. In this case, a load preferably is applied in a direction that resists the extension/retraction of the actuator rod.

Also, in the above embodiments 1 and 2, an elevation unit raises a side of the platform when the platform is tilted, although an elevation unit may, conversely, lower a side of the platform when tilting the platform. In this case, the load-applying unit preferably is structured to apply a load that pushes the platform up, with respect to the tension (upward direction) load exerted on the elevation unit by the platform (i.e. to apply the opposite type of load to the exerted load). The effects described in the above embodiments 1 and 2 are also obtained by this configuration.

### INDUSTRIAL APPLICABILITY

An adjustable bed according to the present invention can be used as a nursing care bed or a reclining bed.

1. An adjustable bed comprising:
a laterally tiltable platform;
a tilt mechanism adapted to tilt the platform laterally; and
a load-applying unit adapted to apply, in a state in which the platform is tilted within a predetermined angle range during operation of the tilt mechanism, a load to the platform in a direction that suppresses an expansion of the tilt angle, so as to prevent one of a compression load and a tension load exerted on the tilt mechanism by the platform from reversing to the other load type.

2. The adjustable bed of claim 1, wherein the predetermined angle range includes a tilt angle at which a gravitational center of the platform during the tilt operation traverses a vertical line containing a rotational center of the platform with the load-applying unit in a non-operational state.

3. The adjustable bed of claim 1, wherein the predetermined angle range is from 30 degrees to 90 degrees inclusive, with reference to the platform in a horizontal state.

4. The adjustable bed of claim 1, wherein the load-applying unit is constituted from a tension spring.

5. The adjustable bed of claim 1, wherein
the load-applying unit has a first member and a second member that, in combination, extend in proportion to a slope of the platform, and a compression spring disposed so as to apply a load in a direction that retracts the combination of the first and second members when the slope of the platform reaches a predetermined tilt angle, and
the predetermined tilt angle is an angle immediately prior to an angle at which a rotational moment around a rotational center that acts on the platform, reverses direction due to self weight during the operation of the tilt mechanism.

6. The adjustable bed of claim 5, wherein the load-applying unit includes a compression spring adapted to apply, at a start of the tilting operation, a load in a direction that extends the combination of the first and second members.

7. The adjustable bed of claim 1, wherein
the tilt mechanism includes an elevation unit disposed on either side of the platform, in order to elevate the platform up and down, and
the platform is tilted laterally by driving one of the elevation units.

8. The adjustable bed of claim 7, wherein
the platform is placed on a support base via a roller disposed on either side of the platform, and
when one side of the platform is raised by the elevation unit corresponding to the side, the roller on the other side rolls over the support base toward the side being raised, and the platform tilts with a center of the roller on the other side as a rotational center.
